(19) United States
(12) Patent Application Publication
(10) Pub. No.: US 2026/0003519 A1
(43) Pub. Date: Jan. 1, 2026

(54) CONTROL LOGIC IN A MEMORY DEVICE FOR GENERATING INTERNAL COMMANDS

(71) Applicant: Micron Technology, Inc., Boise, ID (US)

(72) Inventors: Glen E. Hush, Boise, ID (US); Timothy P. Finkbeiner, Boise, ID (US)

(21) Appl. No.: 19/244,301

(22) Filed: Jun. 20, 2025

Related U.S. Application Data
(60) Provisional application No. 63/664,416, filed on Jun. 26, 2024.

(51) Int. Cl. G06F 3/06

(52) U.S. Cl. CPC G06F 3/0625; G06F 3/0659; G06F 3/0673

(57) ABSTRACT

An apparatus comprising an array of memory cells, a register coupled to the array of memory cells, and control logic coupled to the register and the array of memory cells. The control logic is configured to issue an internal command in response to a memory controller receiving an external command, generate an address corresponding to the internal command, provide the internal command to a row decoder and a column decoder, and instruct a processing unit (PU) to perform multiply-accumulate (MAC) operations on received data.

### PRIORITY INFORMATION

This application claims the benefit of U.S. Provisional Application No. 63/664,416, filed on Jun. 26, 2024, the contents of which are incorporated herein by reference.

### TECHNICAL FIELD

The present disclosure relates generally to memory, and more particularly to apparatuses and methods associated with control logic in a memory device for generating internal commands.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a block diagram of a processing unit in accordance with a number of embodiments of the present disclosure.

FIG. 3 is a block diagram of a plurality of memory banks coupled to control logic in accordance with a number of embodiments of the present disclosure.

FIG. 4 is a block diagram of a memory bank coupled to control logic in accordance with a number of embodiments of the present disclosure.

FIG. 5 is a block diagram of a plurality of memory banks coupled to control logic in accordance with a number of embodiments of the present disclosure.

FIG. 6 is a block diagram of control logic in accordance with a number of embodiments of the present disclosure.

FIG. 7 illustrates an example flow diagram of a method for performing a memory operation using control logic in accordance with a number of embodiments of the present disclosure.

FIG. 8 illustrates an example machine of a computer system within which a set of instructions, for causing the machine to perform any one or more of the methodologies discussed herein, can be executed.

### DETAILED DESCRIPTION

The present disclosure includes apparatuses and methods related to control logic in a memory device for generating internal commands. Control logic that is coupled to a register and an array of memory cells can be configured to issue an internal command in response to a memory controller receiving an external command. Further, the control logic can further be configured to generate an address corresponding to the internal command, provide the internal command to a row decoder and/or a column decoder, and instruct a processing unit to perform multiply-accumulate (MAC) operations on the received data.

In previous memory approaches, commands to be executed on data stored in a memory bank of a memory array are received from a controller external to the memory device. The external controller can send multiple commands to a memory device to be executed using data in a memory bank of the memory device. This results in multiple commands to access data stored in a memory bank being sent from the external controller to the memory device through an input/output (I/O) bus.

However, in such an approach, the I/O bus that transfers the data can become overloaded due to the amount of data being transferred through the I/O bus in a certain amount of time. This can cause the speed at which data is transferred between the external controller and the memory device to decrease. Further, due to the commands and the data that results from the execution of the commands being transferred between the external controller and the memory device, a certain amount of power is used to continuously transfer data between the external controller and the memory device.

In order to address these and other deficiencies of previous approaches, embodiments of the present disclosure include control logic in a memory device that generates commands within the memory device. The control logic can generate an internal command in response to detecting that a memory controller of the memory device received a command from an external component. A register that is included in the control logic can store addresses corresponding to the internal commands. The internal commands can be generated by the control logic. A counter of the control logic can increment the address in a register before a subsequent internal command is issued such that different internal commands have different addresses. The control logic can then instruct a processing unit (PU) of the memory device to execute the internal command.

Generating the commands internally to the memory device using the control logic has the advantage of decreasing the amount of data (e.g., commands and/or addresses) being transferred through an I/O bus between an external component and the memory device. This can avoid the decrease in speed that occurs when the amount of data being transferred through the I/O bus in a certain amount of time overloads the memory system. This also provides the benefit of decreasing the amount of power used by a memory system because the decrease in data being transferred between the external device and the memory device also decreases the amount of power used to transfer data between the external device and the memory device. As used herein, the external component can be referred to as an external device.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

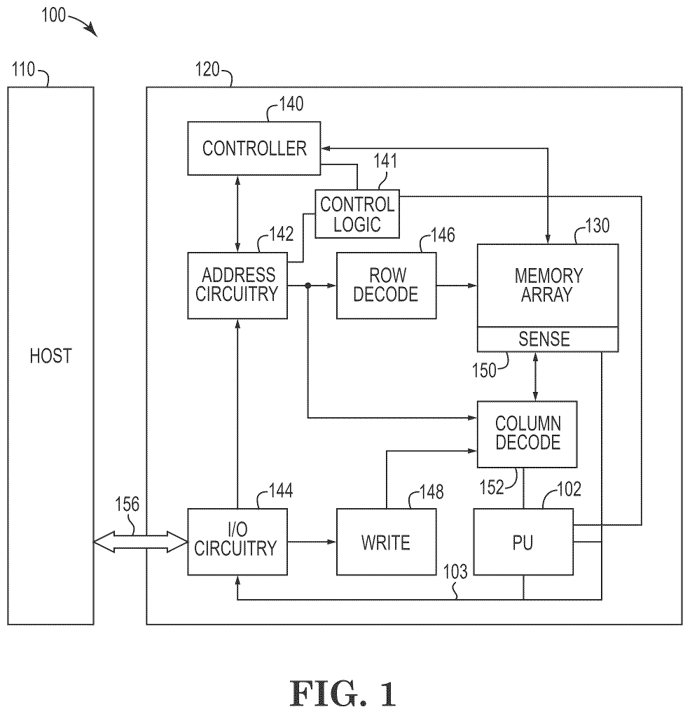

FIG. 1 is a block diagram of an apparatus in the form of a computing system 100 including a memory device 120 in accordance with a number of embodiments of the present disclosure. As used herein, a memory device 120, a memory array 130, and/or host 110 might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks of DRAM cells).

The memory device 120 includes address circuitry 142 to latch address signals provided over an interface 156. The interface can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry 150. The sensing circuitry 150 can comprise, for example, sense amplifiers that can read and latch a page (e.g., row) of data from the memory array 130. The I/O circuitry 144 can be used for bi-directional data communication with host 110 over the interface 156. The read/write circuitry 148 is used to write data to the memory array 130 or read data from the memory array 130. As an example, the circuitry 148 can comprise various drivers, latch circuitry, etc.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by a processing unit (PU) 102. For example, the controller 140 can provide a signal requesting that a matrix-vector multiplication operation be performed to the PU 102. The controller 140 can receive the signal from the host 110 and can cause a matrix of data values and a vector of data values to be sensed (e.g., read) from the memory array 130 and provided to the PU 102. As used herein, the PU 102 can include hardware, firmware, and/or software for performing operations using data provided by the memory array 130. For example, the PU 102 can perform multiplication operations in accordance with embodiments of the present disclosure. The PU 102 can multiply a matrix of data values with a vector of data values. As used herein, a data value is a number that can be used to perform operations such as multiplication operations.

As used herein, a matrix is a grouping of data values organized into rows and columns where each data value has an order in a row and a column. For example, a first data value of a matrix can be a first data value in a first row and a first data value in a first column. A vector is a plurality of data values organized into a single column.

In various instances, the PU 102 can utilize I/O lines 103 to receive the matrix of data values and the vector of data values and to output (e.g., provide) a result vector of data values (e.g., the result of the multiplication operations). The result vector of data values can be stored back to the memory array 130 and/or can be provided to the host 110. Utilizing the same I/O lines 103 to read data from the memory array 130, to provide data to the PU 102, and/or to provide data from the PU 102 can allow for the PU 102 to be added to the memory device 120 without substantially adding to the die area of the memory device 120. For example, the PU 102 can be added to the memory device 120 by increasing a die size of the memory device 120 by 1-3% as compared to solutions that do not include the memory device 120. The 1-3% increase in die size is compared to solutions in which the PU 102 is added to the memory device 120 such that the PU 102 does not receive data and/or provide data via the I/O lines 103.

In various examples, the PU 102 can receive columns of data values of a matrix and data values of a vector from the memory array 130 to perform the matrix-vector multiplication operation. The data values of the matrix can be stored in the memory array 130 such that the data values organized in columns can be read as opposed to reading rows of the memory array 130.

In various instances, the controller 140 can cause data values received from the host 110 to be organized and stored in the memory array 130 such that columns of a matrix are stored in memory cells coupled to a same word line. Providing columns of data values to the PU 102 allows the PU 102 to perform operations on the columns of data value such that the results of the matrix-vector multiplication operation are stored in accumulators of MAC units of the PU 102 without performing additional operations to combine the results into a result vector. Providing the result vector of the matrix-vector multiplication operation utilizing the I/O lines 103 and storing the result vector in accumulators of the MAC units of the PU 102 allows for the result vector to be generated and provided to the I/O lines 103 in the same amount of time as is used to read a single column of a memory address (e.g., 256 prefetch) worth of the matrix and/or the vector from the memory array 130.

Control logic 141 can be coupled to the controller 140, address circuitry 142, and the PU 102. In various instances, the control logic 141 can be internal to the controller 140. Control logic 141 can be configured to generate an internal command in response to detecting the controller 140 received an external command from the host 110. As used herein, the term “internal command” refers to a command that was generated by the memory device 120 and the term “external command” refers to a command that was generated by a memory component external to the memory device. A command can be generated by the memory device 120 if a component (e.g., the control logic 141) of the memory device 120 generates the command. In some embodiments, the control logic 141 can generate the internal command, as well as an address corresponding to the internal command, and send data corresponding to the address that is read from the memory array 130 to the PU 102. In some embodiments, the internal command can be an access command to read data corresponding to the address from the memory array 130. Further, the control logic 141 can provide instructions to the PU 102 to perform operations corresponding to the external command. In some embodiments, the PU 102 can transfer the results of the executed command to the host 110 through the I/O lines 103, the I/O circuitry 144, and the interface 156.

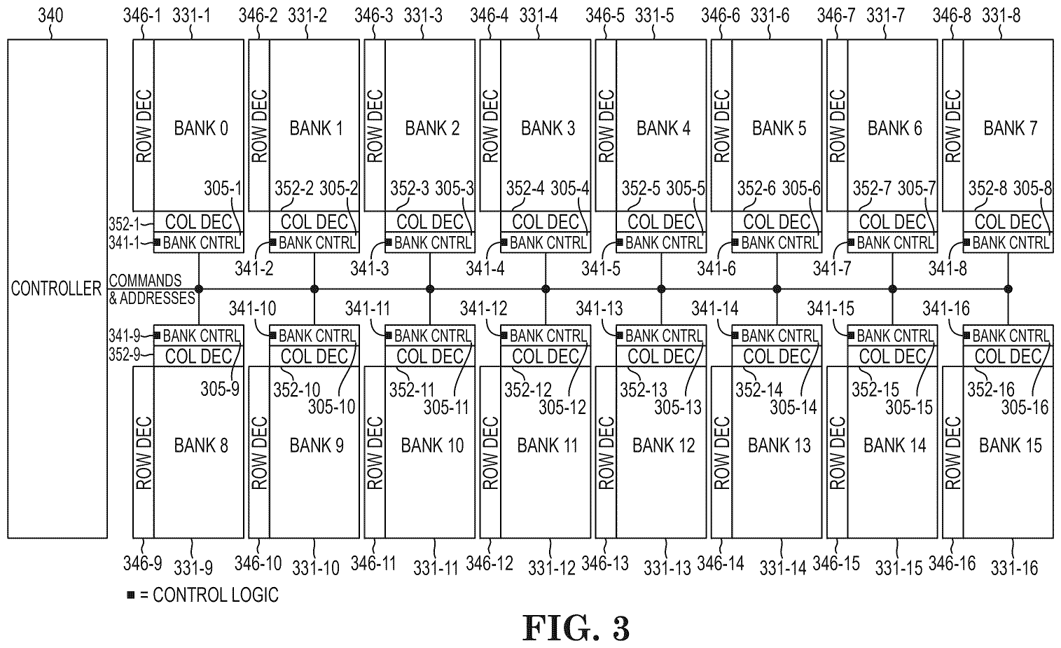

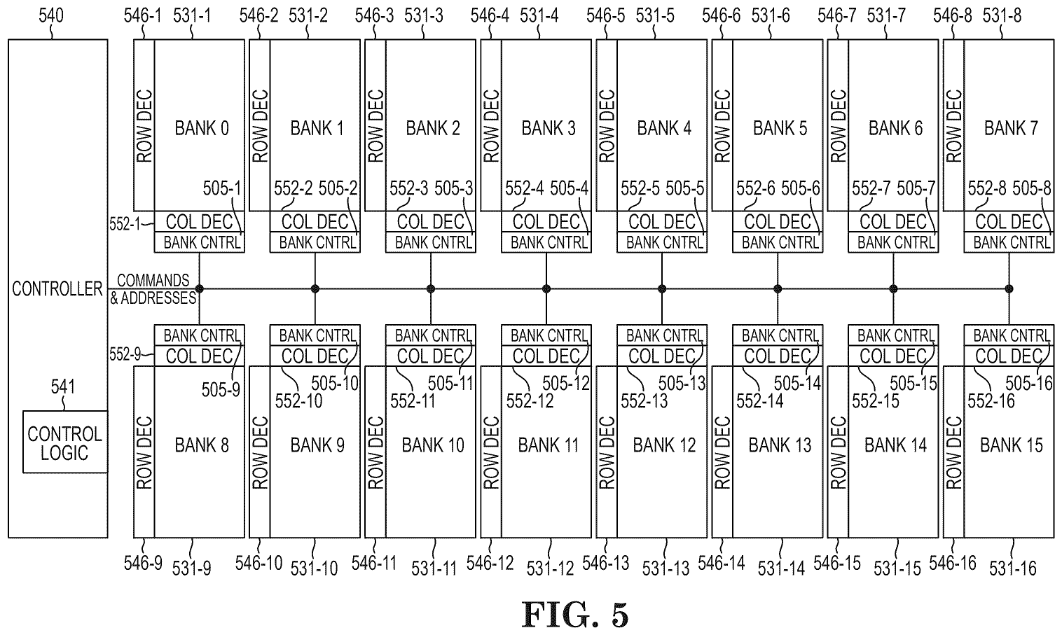

In some embodiments, as shown in FIG. 3, a memory device 120 can include a plurality of control logics 141 and each respective control logic 141 can be located in each respective bank control circuitry coupled to each respective memory bank. In these embodiments, each respective control logic 141 can provide internal commands to the respective memory bank to which it is coupled. Further, in some embodiments, as shown in FIG. 5, a memory device 120 can include a single control logic 141 located in a memory controller 140. In these embodiments, the single control logic 141 can prove internal commands to a plurality of memory banks.

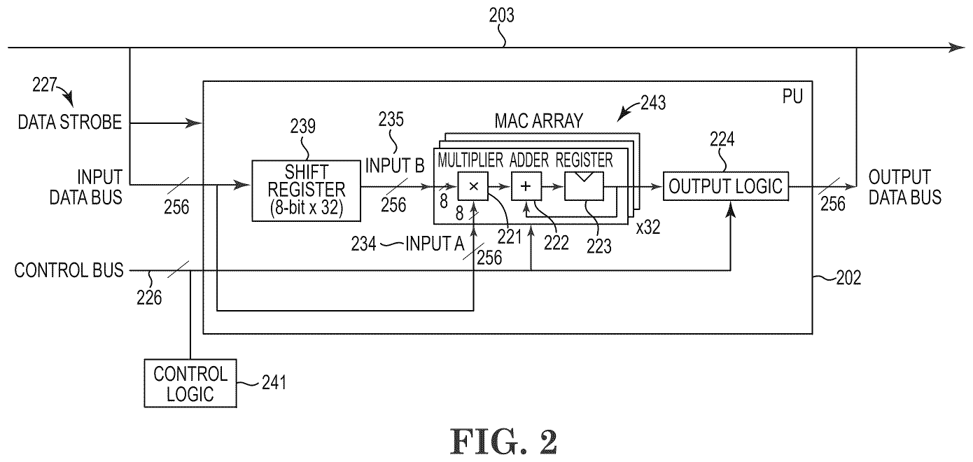

FIG. 2 is a block diagram of a PU 202 in accordance with a number of embodiments of the present disclosure. The PU 202 is coupled to the I/O lines 203. The PU 202 includes the register(s) 239, the MAC units 243, and output logic 224. The PU 202 can receive a data strobe signal 227, a control signal, and input signals. Control logic 241 can be coupled to the PU through a control bus 226.

The input signals can provide data values (e.g., data values 234, 235) of a matrix and/or a vector. The data values of the matrix and/or the vector can be provided sequentially. For example, the data values (e.g., data value 235) of a vector can be stored in the register 239. The data values (e.g., data value 234) of a matrix can be provided directly to the MAC units 243 or can be stored in a different register (not shown) prior to being provided to the MAC units 243. The example of FIG. 2 does not include registers to store the data values of the matrix.

In the example of FIG. 2 a width of the input data bus can be 256-bits. In such an example where the vectors to be operated on include 8 bits, 32 8-bit vectors can be provided in a single 256-bit data chunk. The data values of the matrix can also be provided to the PU 202 in 256-bit chunks. Each of the data values of the vector and the matrix can include 8-bits. The register(s) 239 (Shift Register) can provide each of the data values replicated to fill the 256-bits provided from the registers 239 to the MAC units 243. For example, a first data value (V0) can be replicated thirty-two times to generate 256-bits. Each of the MAC units 243 can receive the same 8-bits (V0) from the 256-bits.

The MAC units 243 can receive the data values from the registers 239 and the data values of the matrix from the I/O lines 203. The MAC units 243 can include multiply circuitry 221, adder circuitry 222, and registers 223. The MAC unit 243 can utilize the multiply circuitry 221, adder circuitry 222, and registers 223 to multiply and accumulate the data values of the vector and the data values of the matrix. The output logic 224 can be controlled to output the output vector. The output vector can be provided to the I/O lines 203.

The data strobe 227 can be utilized to provide timing signals for latching the data values in the registers 239 and for performing the operations of the MAC units 243. The data strobe 227 can also be used to determine when to forward the output vector to the I/O lines 203.

In some embodiments, the control logic 241 can receive a signal from a memory component through the control bus and provide a signal to the PU 202 through the control bus 226. The control signal provided by the control logic 241 via the control bus 226 can provide the PU 202 with instructions to perform a number of operations. For example, the control signal can be utilized to indicate to the registers 239 that the data values should be replicated and/or shifted within the registers 239. The control signal can also indicate to the output logic 224 when to forward the output vector. The data strobe 227 and/or the control signal can be provided by control circuitry of the memory device and/or the control logic 241.

The control signals can be used to load the register 239, forward (e.g., read and/or load) the output vector, and provide data values to the MAC units 243. The control signals can also be used to indicate that the registers 239 should shift data.

FIG. 3 is a block diagram of a plurality of memory banks coupled to control logic in accordance with a number of embodiments of the present disclosure. FIG. 3 includes a controller 340 coupled to a plurality of memory banks 331-1, 331-2, . . . , 331-16 (individually or collectively referred to as memory banks 331), row decoders 346-1, 346-2, . . . , 346-16 (individually or collectively referred to as row decoders 346) coupled to the memory banks 331 and column decoders 352-1, 352-2, . . . , 352-16 (individually or collectively referred to as column decoders 352) coupled to the memory banks 331. FIG. 3 further includes bank control circuitry 305-1, 305-2, . . . , 305-16 (individually or collectively referred to as bank control circuitry 305) coupled to the column decoders 352 and control logic 341-1, 341-2, . . . , 341-16 (individually or collectively referred to as control logic 341) included in the bank control circuitry 305.

In the embodiment shown in FIG. 3, the controller 340 can receive an external command from the host (e.g., host 110 in FIG. 1) and transfer that command to the bank control circuitry 305 of one or more memory banks 331. In response to the one or more bank control circuitries 305 receiving the external command, each respective control logic 341 of the one or more bank control circuitries 305 can generate an internal command and an address corresponding to the internal command. In some embodiments, a plurality of control logics 341 circuitries can each generate a respective internal command and respective address concurrently for different respective memory banks 331. The address for each respective internal command can be stored in a respective register that is included in each respective control logic 341. Each respective control logic 341 can instruct a PU (e.g., PU 202 in FIG. 2) to perform an operation (e.g., a MAC operation) on data corresponding to the internal command.

In some embodiments, the control logic 341 can transfer internal commands to the column decoder 352 circuitry and/or the row decoder 346 circuitry based on a clock signal. As used herein, the term “clock signal” refers to a signal that oscillates between a high state and a low state at a constant frequency. The clock signal can be used to synchronize the actions in a circuit. In some embodiments, the amount of time between the issuance of an internal command and a subsequent internal command can be in a range of 2 clock cycles to 6 clock cycles.

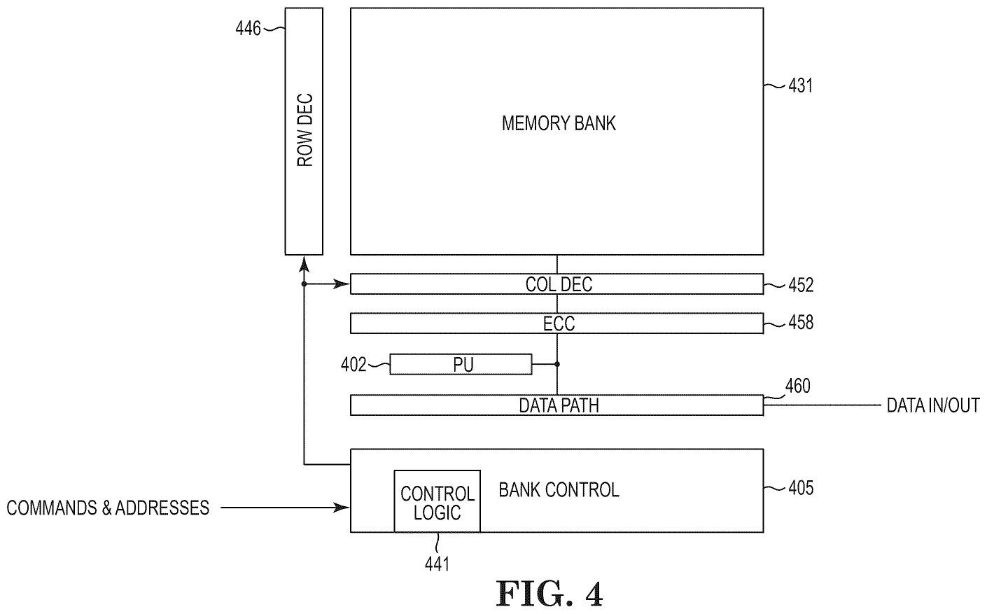

FIG. 4 is a block diagram of a memory bank 431 coupled to control logic 441 in accordance with a number of embodiments of the present disclosure. The memory bank 431 is analogous to any one of the memory banks 331 in FIG. 3. FIG. 4 further includes row decoder 446 circuitry and column decoder 452 circuitry coupled to the memory bank 431, and error correction code (ECC) circuitry 458 coupled to a PU 402 and a data path 460. FIG. 4 further includes bank control circuitry 405 coupled to the row decoder 446 and the column decoder 452, as well as control logic 441 within the bank control circuitry 405.

As shown in FIG. 4, bank control circuitry 405 can receive an external command and address from a memory component external to the memory device. In response to the bank control circuitry 405 receiving the external command and address, the control logic 441 can generate an internal command and an address for the internal command. The internal command can be transferred to the row decoder 446 and the column decoder 452. The row decoder 446 can activate a row in the memory bank 431 corresponding to the address for the internal command and the column decoder 452 can activate a column in the memory bank 431 corresponding to the address for the internal command. The data corresponding to the internal command can be read from the memory bank 431 and sent to the ECC circuitry to be corrected before the data is sent to the PU 402. In some embodiments, the control logic can instruct the PU 402 to perform an operation on the data read from the memory bank 431. The data resulting from the operation performed by the PU 402 can then be sent to a different memory component through the data path 460. In some embodiments, the data path 460 can be an I/O bus.

After data resulting from the operation is sent to a different memory component, the control logic 441 can generate a subsequent internal command and subsequent address for that internal command. The subsequent internal command can be processed in a similar manner as described in regard to the previous internal command. However, in response to receiving the subsequent internal command, the column decoder 452 can activate a subsequent column in the memory bank 431 that corresponds to the subsequent address for the subsequent internal command. In some embodiments, a row decoder 446 can activate a subsequent row in the memory bank 431 in response to the subsequent address corresponding to a different row than a previous address.

In some embodiments, the control logic 441 can generate multiple internal commands and multiple addresses corresponding to those internal commands in response to the bank control circuitry 405 receiving an external command. For example, in response to the bank control circuitry 405 receiving a single external command, the control logic 441 can generate an internal address and an address for the internal address and instruct the internal address to be executed as previously described. The control logic 441 can continue to generate multiple internal commands and corresponding addresses in response to the bank control circuitry 405 receiving the single external command. The control logic 441 can also provide those internal commands to the column decoders 452 and row decoders 446 at specific times according to instructions of the external command. The column decoder 452 can activate different columns corresponding to the addresses of different internal commands. As used herein, the term “activate” refers to applying a current to a column or a row in a memory array such that data stored in a location corresponding to the activated column and activated row can be read by sensing circuitry. In some embodiments, the column decoder 452 can continue to activate different columns for different internal addresses until a stop condition is reached. Further, in some embodiments, multiple rows of a memory bank 431 can be read sequentially before the data that results from the operations performed by the PU 402 are read from the PU 402.

In some embodiments, the term “stop condition” refers to a condition that causes the column decoder 452 to refrain from activating further columns in the memory bank 431 when the stop condition is met. In some embodiments, the stop condition can include, but is not limited to, instructions from the control logic 441 detailing how many columns the column decoder 452 will activate and activating a column on an edge of the memory bank 431 after activating all other remaining columns in the memory bank 431. Further, in some embodiments, the external command can include the stop condition and/or the stop condition can be defined before the external command is sent to the memory device.

FIG. 5 is a block diagram of a plurality of memory banks 531 coupled to control logic in accordance with a number of embodiments of the present disclosure. FIG. 5 includes a controller 540 coupled to a plurality of memory banks 531-1, 531-2, . . . , 531-16 (individually or collectively referred to as memory banks 531), as well as row decoders 546-1, 546-2, . . . , 546-16 (individually or collectively referred to as row decoders 546) and column decoders 552-1, 552-2, . . . , 552-16 (individually or collectively referred to as column decoders 552) coupled to the plurality of memory banks 531. Further, FIG. 5 includes control logic 541 on the controller 540.

In the embodiment shown in FIG. 5, a single instance of control logic 541 can generate internal commands for multiple memory banks 531 in a memory array (e.g., memory array 130 in FIG. 1). In this embodiment, when the controller 540 receives an external command, the control logic 541 can detect the received external command and generate an internal command, as well as an address for the internal command. The control logic 541 can transfer the internal command to memory banks 531 corresponding to the address that was generated for the internal command. In some embodiments, the control logic 541 can transfer (e.g., broadcast) the same internal command and corresponding address to each of the bank controllers 505.

In some embodiments, after the internal command is transferred to the bank control circuitry 505 of the one or more memory banks 531, an address corresponding to an internal command can be stored in a register of the control logic 541. In some embodiments, the address corresponding to the internal command can be stored in the register of the control logic 541 before the internal command is transferred to the bank control circuitry 505 or concurrently with the internal command being transferred to the bank control circuitry 505. After the internal command is transferred to one or more memory banks 531, a counter in the control logic 541 can increment the address stored in the register. In some embodiments, the counter in the control logic 541 can increment the address stored in the register before transferring the internal command to one or more memory banks 531. Further, in some embodiments, the counter in the control logic 541 can increment the address stored in the register multiple times before transferring the internal command to one or more memory banks 531. Incrementing the address stored in the register can result in a subsequent address being generated when a subsequent internal command is generated such that a subsequent internal command can have a different address than a previous internal command.

As stated previously, the control logic 541 can generate multiple internal commands and corresponding addresses in response to the controller 540 receiving a single external command. Further, as stated previously, the column decoder 452 can continue to activate different columns for different internal addresses until a stop condition is reached.

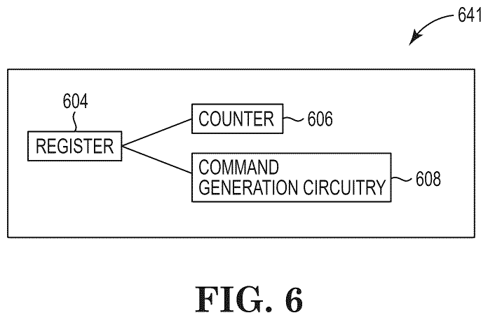

FIG. 6 is a block diagram of control logic 641 in accordance with a number of embodiments of the present disclosure. The control logic 641 can include a register 604, a counter 606 coupled to the register, and command generation circuitry 608 coupled to the register 604. The control logic 641 is analogous to control logic 341 in FIG. 3 and control logic 541 in FIG. 5.

As stated previously, the control logic 641 can generate an internal command in response to a memory controller (e.g., memory controller 140 in FIG. 1) receiving an external command. More specifically, the command generation circuitry 608 can generate an internal command in response to the memory controller receiving an external command. An address for the internal command can be stored in the register 604. In some embodiments, the external command can be a read command and the internal command can be a modified read command. As used herein, the term “modified read command” refers to a read command that is generated by the command generation circuitry 608.

In some embodiments, the counter 606 can be configured to increment an address stored in the register 604 such that the address stored in the register 604 after the address is incremented is different than the address stored in the register 604 before the address is incremented. The address stored in the register 604 after the address is incremented can be an address for a subsequent internal command that is generated after a previous internal command is executed.

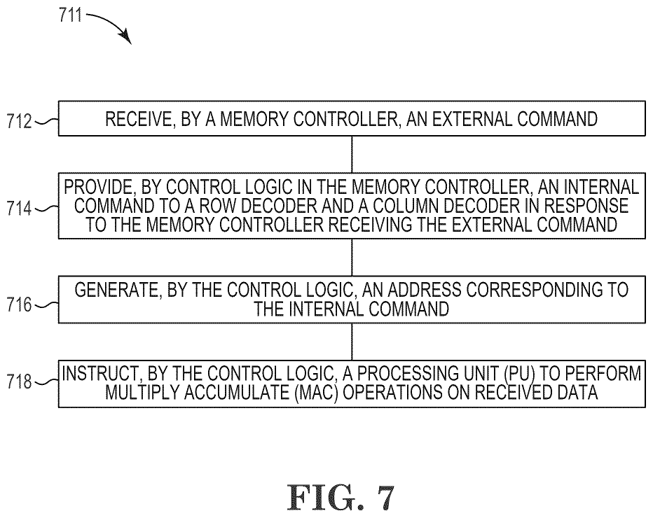

FIG. 7 illustrates an example flow diagram of a method 711 for performing a memory operation using control logic in accordance with a number of embodiments of the present disclosure. The method 711 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 711 is performed by the control logic 141, 241, 341, 441, 541, and 641 of FIGS. 1-6, respectively. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 712, the method 711 can include receiving, by a memory controller, an external command. In some embodiments, the external command can be a read command or a write command. Further, the external command can be sent to the memory controller by an external memory component such as a host (e.g., host 110 in FIG. 1) external to the memory device (e.g., memory device 120 in FIG. 1) or a controller external to the memory device.

At block 714, the method 711 can include providing, by control logic in the memory controller, an internal command to a row decoder and a column decoder in response to the memory controller receiving the external command. At block 716, the method 711 can include generating, by the control logic, an address corresponding to the internal command. In response to the row decoder and the column decoder receiving the command, the row decoder can activate a row in a memory bank corresponding to the address of the internal command and the column decoder can activate a column corresponding to the address of the internal command.

In some embodiments, instead of a single instance of control logic being located on a memory controller, a different instance on control logic can be located on each respective bank control circuitry coupled to each respective memory bank. In these embodiments, each respective control logic can send an internal command to the respective row decoder and the respective column decoder of the same memory bank to which the respective control logic is coupled.

At block 718, the method 711 can include instructing, by the control logic, a PU to perform MAC operations on received data. A MAC operation can be an operation to multiply two numbers and add the result of that multiplication to an accumulator. An accumulator can be a register used to store intermediate logical or arithmetic data in multistep calculations.

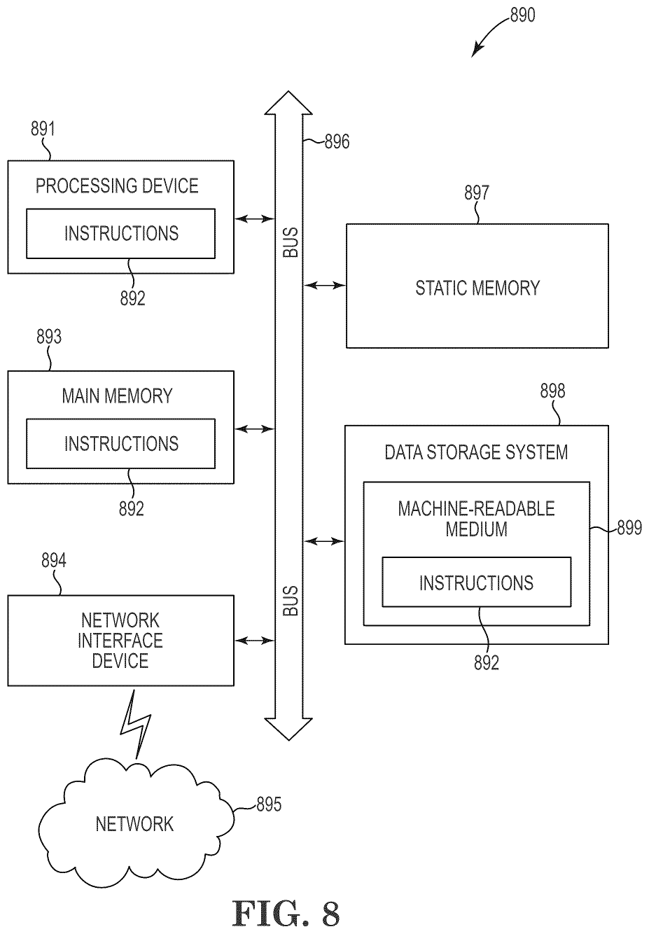

FIG. 8 illustrates an example machine of a computer system 890 within which a set of instructions, for causing the machine to perform any one or more of the methodologies discussed herein, can be executed. In some embodiments, the computer system 890 can correspond to a host system (e.g., the system 100 of FIG. 1) that includes, is coupled to, or utilizes a memory system (e.g., the memory device 120 of FIG. 1) or can be used to perform the operations of the PU (e.g., the PU 102 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 890 includes a processing device 891, a main memory 893 (e.g., read-only memory (ROM), flash memory, dynamic random access memory (DRAM) such as synchronous DRAM (SDRAM) or Rambus DRAM (RDRAM), etc.), a static memory 897 (e.g., flash memory, static random access memory (SRAM), etc.), and a data storage system 898, which communicate with each other via a bus 896.

Processing device 891 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 891 can also be one or more special-purpose processing devices such as an application specific integrated circuit (ASIC), a field programmable gate array (FPGA), a digital signal processor (DSP), network processor, or the like. The processing device 891 is configured to execute instructions 892 for performing the operations and steps discussed herein. The computer system 890 can further include a network interface device 894 to communicate over the network 895.

The data storage system 898 can include a machine-readable storage medium 899 (also known as a computer-readable medium) on which is stored one or more sets of instructions 892 or software embodying any one or more of the methodologies or functions described herein. The instructions 892 can also reside, completely or at least partially, within the main memory 893 and/or within the processing device 891 during execution thereof by the computer system 890, the main memory 893 and the processing device 891 also constituting machine-readable storage media.

In one embodiment, the instructions 892 include instructions to implement functionality corresponding to the controller 140 of FIG. 1. While the machine-readable storage medium 899 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
an array of memory cells;
a register coupled to the array of memory cells; and
control logic coupled to the register and the array of memory cells, the control logic configured to:
issue an internal command in response to a memory controller receiving an external command;
generate an address corresponding to the internal command;
provide the internal command to a row decoder and a column decoder; and
instruct a processing unit (PU) to perform multiply accumulate (MAC) operations on received data.

2. The apparatus of claim 1, wherein the PU is a multiply accumulate (MAC) unit.

3. The apparatus of claim 1, wherein the register is coupled to a counter.

4. The apparatus of claim 3, further comprising the counter configured to increment the address, wherein the address stored in the register.

5. The apparatus of claim 1, further comprising the control logic configured to receive a read command as the external command.

6. The apparatus of claim 1, further comprising the control logic configured to generate a modified read command as the internal command.

7. The apparatus of claim 1, wherein a controller external to the array of memory cells issues the external command.

8. A method, comprising:
receiving, by a memory controller, an external command;
providing, by control logic in the memory controller, an internal command to a row decoder and a column decoder in response to the memory controller receiving the external command;
generating, by the control logic, an address corresponding to the internal command;
instructing, by the control logic, a processing unit (PU) to perform multiply accumulate (MAC) operations on received data.

9. The method of claim 8, further comprising executing the internal command on multiple memory banks within a memory array.

10. The method of claim 8, further comprising incrementing an address in the control logic in response to the PU executing the internal command.

11. The method of claim 8, further comprising storing the address corresponding to the internal command in a register located in the control logic.

12. The method of claim 11, further comprising storing a subsequent address corresponding to a subsequent internal command in the register in response to an address incrementing.

13. The method of claim 8, further comprising issuing a plurality of internal commands in response to the memory controller receiving the external command.

14. An apparatus, comprising:
a memory controller;
an array of memory cells coupled to the controller;
a register coupled to the array of memory cells; and
control logic coupled to the array of memory cells and the register, wherein a respective control logic and a respective register are coupled to each respective memory bank within the array of memory cells, and wherein the control logic is configured to:
issue an internal command in response to the memory controller receiving an external command;
generate an address corresponding to the internal command;
provide the internal command to a row decoder and a column decoder; and
instruct a processing unit (PU) to perform multiply accumulate (MAC) operations on received data.

15. The apparatus of claim 14, further comprising a respective bank control circuit coupled to each respective memory bank.

16. The apparatus of claim 15, wherein the respective control logic and a respective register are located within each respective bank control circuit.

17. The apparatus of claim 16, wherein each respective control logic generates a respective internal command and provides that respective internal command to a respective column decoder and a respective a row decoder coupled to a same respective memory bank.

18. The apparatus of claim 14, further comprising the respective control logic of each respective memory bank generating and providing a respective internal command to each corresponding, respective memory bank concurrently.

19. The apparatus of claim 18, wherein the PU is coupled to an input/output (I/O) bus.

20. The apparatus of claim 19, wherein a respective PU is coupled to a respective column decoder of each respective memory bank.
